(19) United States
(12) Patent Application Publication
(10) Pub. No.: US 2002/0188432 A1
(43) Pub. Date: Dec. 12, 2002

(54) Circuit model generation and circuit model testing

(76) Inventors: Thomas Sean Houlihane, Cambridge (GB); Richard David Ellis, Clare (GB)

Correspondence Address: NIXON & VANDERHYE P.C., 1100 North Glebe Road, 8th Floor, Arlington, VA, 22201-4714, US

(21) Appl. No.: 09/854,491

(22) Filed: May 15, 2001

(51) Int. Cl. G06F 9/44

(52) U.S. Cl. 703/20

(57) ABSTRACT

A test bench generation technique is described in which a simulation of test operation is performed using a full subsystem circuit model 2 and full surrounding circuit models 4, 6, and 8. The input and output signals are recorded as a print on change file 10. This print on change file is used in combination with a classification of whether signals are inputs, outputs or bidirectional and associated rules for outputs and bidirectional signals when outputs to establish a reduced model concentrating on the interaction between the subsystyem circuit under test and the surrounding circuit elements. This reduced model 34 replays input data and applies rules to output data rather than actually modelling the full behaviour of the surrounding circuits. The rules associated with output signals can involve time windows, strobing relationships, settling times and settled times amongst other characteristics.

### BACKGROUND OF THE INVENTION

1. Field of the Invention

This invention relates to the field of data processing systems. More particularly, this invention relates to the field of modelling data processing systems comprising a subsystem circuit under test and one or more surrounding circuits operable to provide input signals to and receive output signals from the subsystem circuit.

2. Description of the Prior Art

In the development of a typical integrated circuit design, whether an entire integrated circuit or part of an integrated circuit (e.g. a peripheral), verification forms a significant part of the design effort. The verification typically involves the use of a test bench model and a suite of simulations that are defined at some point within the project and periodically run using the latest variants of the design as the design evolves. This procedure is known as regression testing and is often a troublesome bottleneck in the design process.

FIG. 1 of the accompanying drawings illustrates a model that may be used in such testing. The subsystem under development has a subsystem model 2. This interacts with various surrounding circuit models 4, 6, 8. The models of the surrounding circuits 4, 6, 8 may be highly complex (e.g. a memory system model may seek to simulate real life behaviour of a memory system in terms of the time delays between data access requests and the data being returned, as well as other relatively sophisticated non uniform behaviour of a memory system). Whilst the full model shown in FIG. 1 is able to produce an accurate simulation, it suffers from the disadvantage that the simulation can take many hours to run. This can be a critical time constraint in the development of a product.

A further problem with the system illustrated in FIG. 1 is that it may be desired to release the model to customers so that they can perform their own further regression testing or other types of testing should they change the subsystem circuit.

In these circumstances, the models of the surrounding circuits 4, 6, 8 may be proprietary to third parties with the intended customer having no right to use those models. Furthermore, certain of the model elements may be proprietary to the provider of the subsystem circuit with the particular customer not having the right to use those proprietary circuit portions. In either case, it is either not possible or undesirable to release the full surrounding circuit models 4, 6, 8 of FIG. 1 in all cases.

### SUMMARY OF THE INVENTION

Viewed from one aspect the present invention provides a method of creating a model of a data processing apparatus having a subsystem circuit under test and one or more surrounding circuits operable to provide input signals to and receive output signals from said subsystem circuit, said method comprising the steps of conducting a simulation of said data processing apparatus performing a test sequence of data processing operations including simulating operation of both said subsystem under test and said one or more surrounding circuits using a subsystem circuit model and a model of said one or more surrounding circuits; recording input signals to and output signals from said subsystem circuit whilst performing said test sequence of data processing operations; and using at least a representation of said recorded input signals to form a reduced model to replay said recorded input signals to said subsystem circuit model without requiring a periodic sampling reference and apply a plurality of sampling rules to output signals of said subsystem circuit model to sample said output signals and to compare said output signals with one or more predetermined characteristics indicative of correct operation; whereby said subsystem model and said reduced model may be used to simulate said subsystem performing said test sequence of data processing operations without simulating operation of said one or more surrounding circuits.

The invention recognises that once a test has been defined and run using the subsystem circuit model 2 (which may have a wide variety of forms, such as a detailed netlist, a high level abstract model, or a physical FPGA model) and the surrounding circuit model 4, 6, 8, then outputs from the subsystem circuit should not change if no changes are made to the subsystem circuit. Accordingly, a full model of the surrounding circuits is no longer required to perform those tests and instead recorded input signals can be replayed to the subsystem circuit and output signals captured and compared with associated characteristics. The reduced model so produced can operate significantly faster than the full model of the surrounding circuits and accordingly speed up the regression testing process. Furthermore, the reduced model does not include the full information regarding the surrounding circuits that it may not be desired to release. Compared to a simple cycle based approach in which test vectors are replayed and responses recorded, the reduced model is more flexible and more compact as well as allowing more sophisticated types of analysis. The reduced model does not force any artificial timing restrictions due to cycle based sampling approaches and tends not to generate the impractically large file sizes that can be associated with cycle based approaches.

The configuration files used in conjunction with the recorded signals could take various different forms, but are preferably files specifying whether signals are input signals, output signals or bidirectional signals. This data may then be used to control the automatic generation of the required portion of the reduced model to replay input signals in the correct sequence and time, or capture output signals with appropriate timing constraints and interdependencies associated therewith. This also allows timing models to be defined for association with signals thereby reducing the overall work required to produce a model.

The reduced model may provide the ability to verify the correct operation of an output signal by associating an output signal time window with a change in that output signal during the reference simulation. The output signal should change, to a predetermined state, such as high, low, changed or high impedance, within that time window.

Some of the output signals may be strobe signals that control the sampling of other output signals and this behaviour can be modelled within the reduced model. Both the strobe output signal and the strobed output signal may have time windows associated with them. A strobe output signal should change to its desired predetermined state (e.g. strobe signals may only be active on a rising edge and otherwise ignored) within an associated strobe output signal time window and the strobed output signals should hold their value within a strobed signal time window. The strobed signal time window may be asymmetrically disposed about is sampling point and may be surrounded by a settling window and a settled window. More than one signal may strobe a strobed signal.

It is inherent that the subsystem circuit model will change between the recording of the signals and subsequent testing of a model of a new version of that subsystem circuit at a later time. The new version of the subsystem circuit model could be in an entirely different form to that used when recording, such as a change between an RTL form and a netlist form. The technique allows the significant functionality of the sub-system to be accurately verified.

Preferred embodiments of the invention also allow changes in the output signals to be recorded other than at sampling points. This may be useful is diagnosing unpredictable or undesirable behaviour in the system, even if this does not affect the functionality, when it may not be observed by the original model.

Viewed from another aspect the invention also provides a method of modelling a data processing apparatus having a subsystem circuit under test and one or more surrounding circuits operable to provide input signals to and receive output signals from said subsystem circuit, said method comprising the steps of:

providing a subsystem circuit model and a reduced model;

using said reduced model to apply a sequence of previously recorded input signals to a model of said subsystem circuit, said input signals corresponding to those provided by said one or more surrounding circuits to said subsystem circuit when performing a test sequence of data processing operations; and

using said reduced model to apply a sampling rule associated with each output signal of said subsystem circuit to sample said output signal and compare said output signal with one or more predetermined characteristics indicative of correct operation.

This aspect of the invention relates to the reduced model itself in combination with the subsystem circuit model.

Other aspects of the invention provide data processing apparatus for performing the above described methods and computer programmes for controlling computers to perform these methods.

### BRIEF DESCRIPTION OF THE DRAWINGS

The above and other objects, features and advantages of the invention will be apparent from the following detailed description of illustrative embodiments which is to be read in connection with the accompanying drawings in which:

FIG. 1 illustrates a known modelling technique;

FIG. 2 illustrates the recording of signal data from a full subsystem circuit model and a full surrounding circuits model;

FIG. 3 is a flow diagram illustrating production of a reduced model;

FIG. 4 is a diagram illustrating the reduced model in combination with the full model of the subsystem circuit;

FIG. 5 illustrates examples of rules that may be associated with output signals; and

FIG. 6 illustrates a general purpose computer of the type that may be used to carry about the above described techniques; and

FIG. 7 illustrates a process flow in accordance with one embodiment of the invention.

### DESCRIPTION OF THE PREFERRED EMBODIMENTS

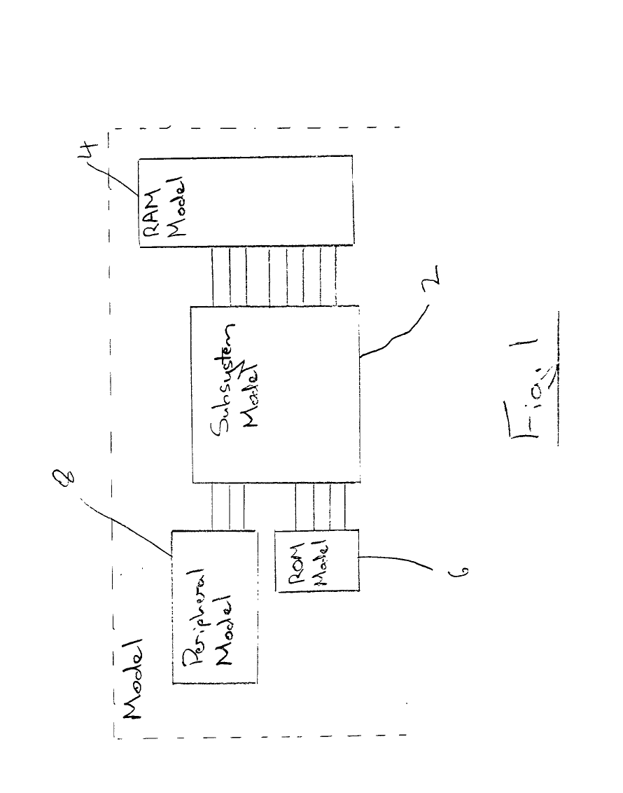

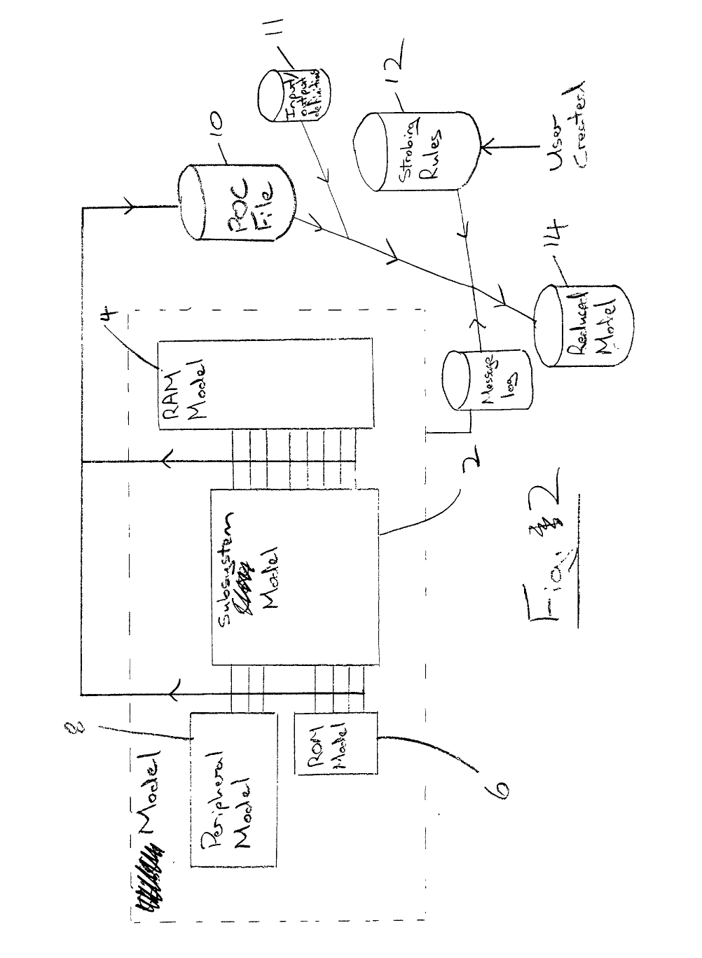

FIG. 2 illustrates the full subsystem circuit model 2 and full surrounding circuits model 4, 6, 8 previously discussed in relation to FIG. 1 but in this case shows the recording of a print on change (POC) file and message log 10. The mechanisms for recording such POC files and associated message logs are known and already provided within circuit simulation systems.

Once the POC file 10 has been created it may be combined with user defined rules 12 to be associated with the output signals and may be used to control the correct sampling of those output signals and checking that they have the required characteristics. The POC file 10, the rules 12, the message log and the input/output definitions may also be used to at least semi-automatically produce a reduced model 14. Then various data files could be combined in many different ways.

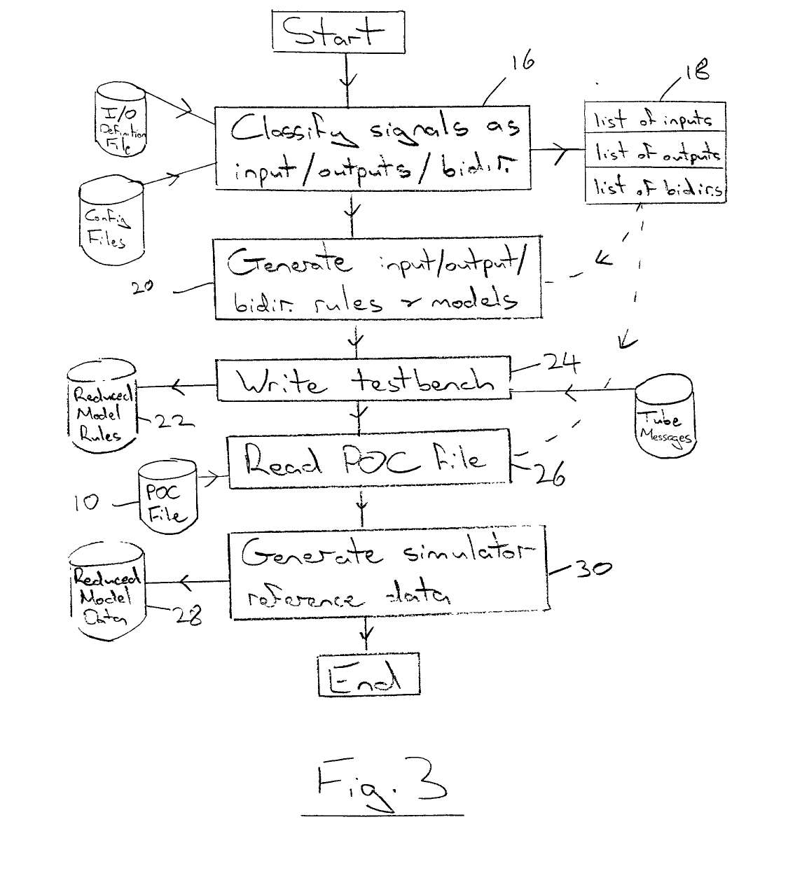

FIG. 3 is a flow diagram schematically illustrating the generation of the reduced model 14. At step 16, the input/output definition file 11 may be parsed to identify and classify signals as either input signals, output signals or bidirectional signals. A bidirectional signal will have a configuration signal associated with it that controls whether it is either an input signal or an output signal at a particular point in time. It may be necessary to adjust the timing of bidirectional signals to ensure that the signal is never driven by the test bench whilst it is still an output. This can vary as the delay through the output stage changes, but will have defined limits which may be used in the generation of the test bench. The generation of repetitive clocks can be modelled within the reduced model, rather than requiring data from the data file 28. The list of signals 18 produced by step 16 is then used at step 20 to generate models that can serve to replay the recorded input signals within the POC file 10 in response to data drawn from the POC file 10. Furthermore, rules may be established to associate the signals controlling whether a bidirectional signal is an input or an output with that bidirectional signal as well as to define the times at which output signals should be sampled or the ranges of times within which output signals should change. For certain output signals, correct operation may be verified by observing that they have adopted a predetermined state (e.g. high, low, high impedance or changed) within a predetermined time window. Within this class of output signals, some will also be strobe signals that themselves may be used to qualify the correct operation of other output signals. Typically, a strobe signal will transition (e.g. a rising edge) to indicate that one or more strobed signals should be sampled at that point by another portion of the overall system. In order that correct operation should be maintained, the strobed signals should have reached their desired state a certain time before the sampling point and maintain their desired state for a certain time after the sampling point (these may be non equal times). A strobed signal may have a settling window around its hold window and possibly also a settled window around its settling window, if desired. Thus, for output signals a relatively wide range of behaviours may be simply specified and correct operation of a modified subsystem circuit checked against these behaviours. Output signal values may also be monitored at other times, or at least their changes noted.

It should be appreciated that in many cases the output signals will be bus signals and may be treated as such to avoid replicating the rule many times thereby reducing the work associated with generating the rules.

Once the rules have been established at step 20, the test bench model rules 22 for carrying out these rules may be written at step 24. These rules may be effectively embodied as portions of computer program code or model controlling data or model code that reside within or control a circuit simulation system. The reduced model and its associated data file will allow simulation of the sub-system on a variety of simulation platforms.

At step 26, the POC file 10 is read to extract the data to be replayed and verified using the reduced model now created. This data 28 is generated at step 30.

When later using the model that has been generated, the systems detects changes and times of changes in signals, reads in the preformatted data with the expected times and values and compares the results to verify correct operation.

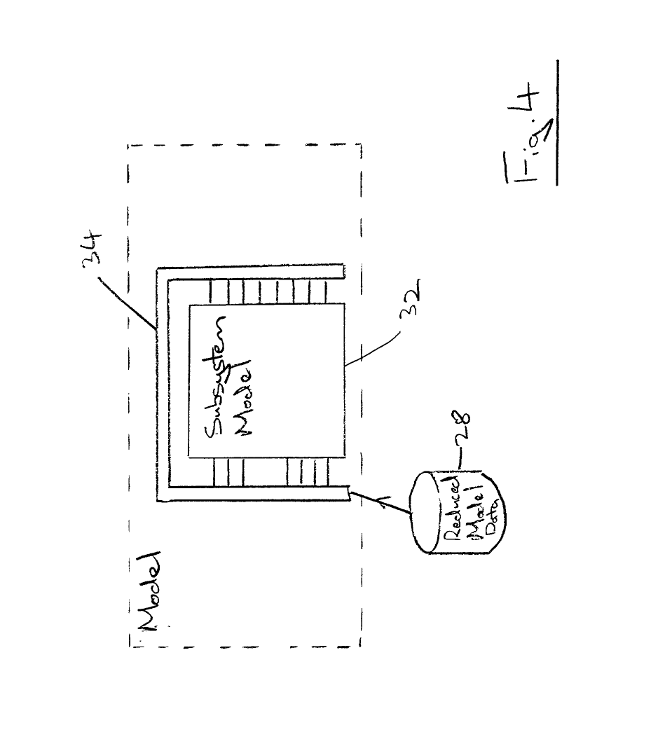

FIG. 4 illustrates a full subsystem circuit model 32 surrounded by a reduced model 34 created in accordance with the above techniques. The subsystem model 32 will typically be changed from that used in FIG. 2 to record the test data since it is the continued correct operation of this changed circuit that it is desired to verify. The changed model could be represented in a different form, such as a net list form or a modified RTL form compared with that of FIG. 2.

Compared with the full task of simulating the operation of all of the surrounding circuits as illustrated in FIGS. 1 and 2, the reduced model 34 has the considerably simpler task of replaying the recorded data and applying predetermined rules to the observed outputs. The reduced model does not model the full behaviour of the surrounding circuits and is quite insensitive to their internal workings, rather it concentrates on modelling the interaction between those surrounding circuits and the subsystem circuit model under test. This considerably reduces the simulation processing load and avoids the need to release proprietary information that may be contained within the full surrounding circuit models. Also, a subset of tests can be run if some parts of the subcircuit are known to have changed.

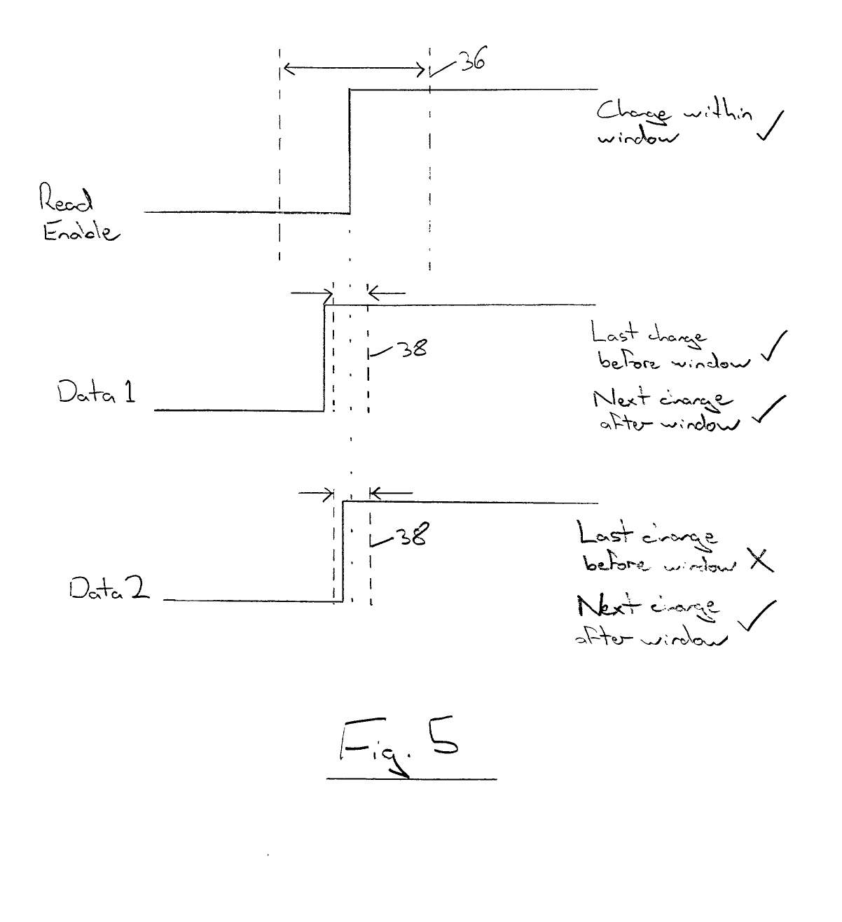

FIG. 5 illustrates some example rules associated with output signals. A read enable signal is a strobe signal used to control reading from a data bus. Correct operation of this signal is defined in a rule as a rising edge occurring within a time window 36 and then being maintained within that window. The example illustrated shows this desired behaviour and would pass the rule.

The Data1 signal is a strobed signal controlled to be sampled at a time corresponding to the rising edge of the read enable signal. The correct characteristics of this signal are that it should have had its last change before the time window 38 and should not have its next change until after the time window 38. Although not illustrated, the time window 38 could be associated with a settling window on one or both sides within which the output signal was allowed to change and this further surrounded on one or both sides by a settled window within which the output signal was not allowed to change.

The Data2 signal is also a strobed signal controlled by the read enable signal. In this case the signal is subject to the same time window 38, but does not show the desired characteristics in that the last change occurred within the window period rather than before the window period. The signal Data2 showing these characteristics may indicate that a change has been made in the subsystem circuit that is causing one of the output signals not to show the required characteristics and accordingly may result in malfunction of the system as a whole if such a circuit were fabricated in hardware. Having identified this incorrect operation, the cause may then be investigated and a solution applied.

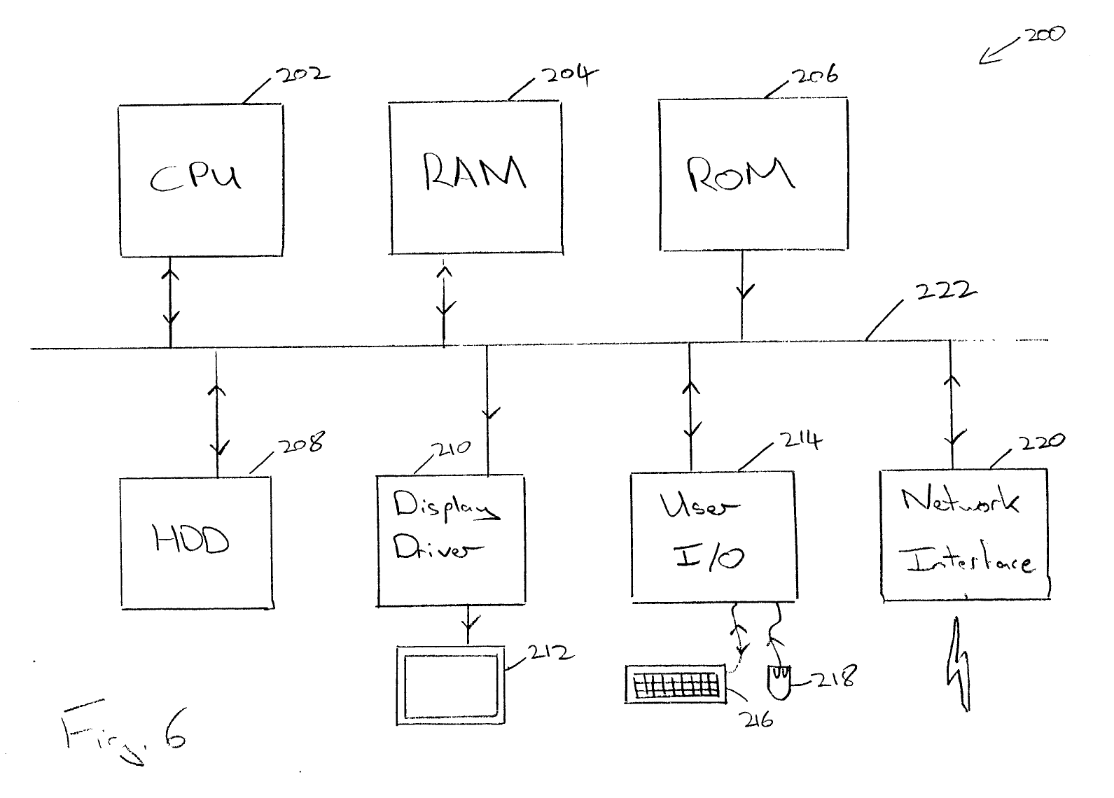

FIG. 6 schematically illustrates a computer 200 of a type that may be used to execute the computer programs described above. The computer 200 includes a central processing unit 202, a random access memory 204, a read-only memory 206, a hard disk drive 208, a display driver 210 and display 212, a user input/output circuit 214, a keyboard 216, a mouse 218 and a network interface circuit 220, all coupled via a common bus 222. In operation, the central processing unit 202 executes computer programs using the random access memory 204 as its working memory. The computer programs may be stored within the read-only memory 206, the hard disk drive 208 or retrieved via the network interface circuit 220 from a remote source. The computer 200 displays the results of its processing activity to the user via the display driver 210 and the display 212. The computer 200 receives control inputs from the user via the user input/output circuit 214, the keyboard 216 and the mouse 218.

The computer program product described above may take the form of a computer program stored within the computer system 200 on the hard disk drive 208, within the random access memory 204, within the read-only memory 206, or downloaded via the network interface circuit 220. The computer program product may also take the form of a recording medium such as a compact disk or floppy disk drive that may be used for distribution purposes. When operating under control of the above described computer program product, the various components of the computer 200 serve to provide the appropriate circuits and logic for carrying out the above described functions and acts. It will be appreciated that the computer 200 illustrated in FIG. 6 is merely one example of a type of computer that may execute the computer program product, method and provide the apparatus described above.

Further details of the techniques described above may be found in the following:

Terms and abbreviations
This document uses the following terms and abbreviations.

| Term | Meaning |
|---|---|
| SoC | System On Chip |
| AMBA | Advanced Microcontroller Bus Architecture |
| APB | Advanced Peripheral Bus |
| ASB | Advanced System Bus |
| AHB | Advanced High Performance Bus |
| DMA | Direct Memory Access |
| PrimeCell | Re-usable IP blocks designed by ARM for |
| | SoC designs |
| Trickbox | PrimeCell test block, designed to interface to |
| | non AMBA bus ports. |
| TIC | Test Interface Controller |
| CRF | Simulation replay tool |
| POC | Print on change simulation log file format |
| DUT | Device under test |

### Scope

This document is intended as a design specification for a software tool to be used by ARM, initially in the SoC group. In addition to specifying the product, it explains the benefits of the tool. This document specifies the requirements, but does not attempt to fully document the detail of the implementation.

### Introduction

In a typical SoC ASIC or peripheral project, verification forms a significant part of the design effort. Once a test bench and a suite of sumulations have been defined, it is likely that the same simulations will be run periodically as the design evolves. This approach, which is known as regression testing, verifies that modifications do not affect unrelated parts of the design, and also possibly that different views are equivalent (eg, netlist/RTL, best-case timing/worst-case timing). As the design nears completion, the pressure to complete regression testing as quickly as possible increases, and the number of tests to be performed increases. With each test typically taking many hours to run, any improvement in simulation speed would be advantageous.

It is normal for the verification test bench to be included as a project deliverable, for IP blocks as well as SoC's.

In many cases additional IP which is not a deliverable of the project is incorporated into the test bench. Examples of this include Specman IP, Denali memory models, and pre-existing blocks which are not deliverables but are part of the test bench infrastructure, for example a DMA controller.

A tool already exists at ARM to allow for replaying a simulation, this is “CRF”. Whilst this is of benefit, it has serious limitations which stem from that fact that it is a cycle based approach:

Timing accuracy is difficult or impossible to preserve precisely, potentially requiring an extremely short cycle period.

File size is often an issue, as it multiplies with length of simulation, number of i/o and inverse of cycle time.

These restrictions are currently a severe restriction on the viability of CRF simulations for anything more than a module such as a single PrimeCell. A solution is required which scales with the large designs & long simulations typical in SoC.

### Test Bench Generator

A tool is proposed which takes the output from a simulation using a potentially complex test bench incorporating VHDL/Verilog models, Denali models, Specman models, and from this generates a “minimal test bench”. This minimal test bench then allows the simulation to be replayed exactly whilst preserving exact timing but without the need for the original test bench IP. This tool, which we are naming “TBGen” (Test Bench Generator), provides a test bench delivery mechanism which encapsulates test bench IP. It offers three key advantages:

removes the need for licenses to the test bench I P, eg Specman/Denali,

obfuscates the test bench IP,

significant improvement in simulation speed.

It does not rely a cycle-based approach, and it does not generate unwieldy intermediate files.

TBGen processes a POC (Print On Change) file from a simulation run and a file defining the inputs and sampling information for outputs. Bidirectional signals can be accommodated by tracing the bidir-enable signals. The POC file is then processed by TBGen to generate an output file which can be of 2 types, as required by the user:

VHDL or Verilog file containing stimuli & expected responses;

Native simulator command file. (TBD: this format should deliver the ultimate in simulation speed but it may not be worthwhile implementing this format. This format is not considered any further in this document).

It should be noted that it is not necessary to actually create the POC file (which might be large), instead the Unix pipe can be used to output directly into TBGen “on the fly” (this means that TBGen must allow the POC to be delivered as “stdin”).

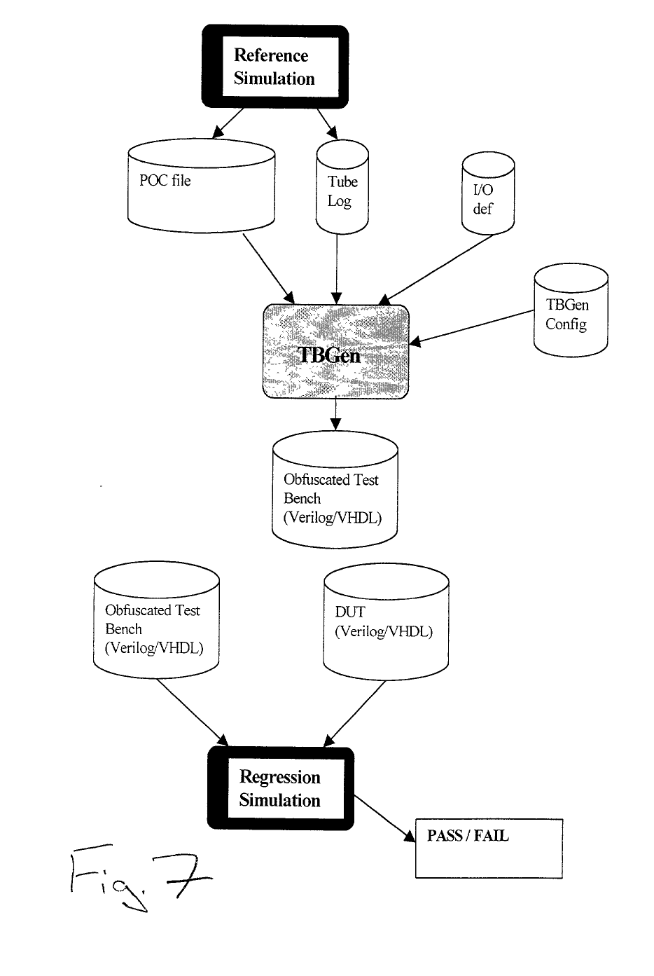

The FIG. 7 shows the flow for using TBGen to deliver an obfuscated test bench, the details are deferred until later.

The POC file is produced from the reference simulation in the original test bench. As well as the POC file, additional files are required to configure TBGen's output:

the IO-definition file, ‘.iod’,

the configuration file, ‘.tbc

the tube messages file ‘.tmf’ (optional).

The .iod file specifies to TBGen which pins are inputs and which are outputs, along with other relevant data such as setup & hold specifications. The ‘.tbc’ file specifies the configuration for TBGen, e.g. Verilog or VHDL output. The ‘.tmf’ file contains timestamped tube messages which allows TBGen to recreate the environment messages that appeared in the reference simulation (“Removing Reset” . . . ).

### Test Bench Delivery Mechanism

Even if the original test bench relies on licensable IP and 3^{rd} party products, a particular simulation run can be reconstructed without needing to deliver any test bench IP. The only restriction that this imposes is that it is impractical to modify the test stimuli. However, note: it is still possible to attach protocol checkers and view the progress of the simulation. This might be seen as a restriction on the functionality of this tool, but in practice a customer who wishes to make significant modifications to a test bench is likely to have suitable tools and models to achieve verification of their design which incorporates ARM IP. The TBGen test bench delivers an “out of box” test to the end user.

Since the test bench run is converted to a new Verilog or VHDL file, any simulation will be readily portable to different simulators. There are unlikely to be any significant issues with maintaining compatibility with future versions of simulators.

TBGen does not displace the requirement to deliver a device trickbox (a functional model to interface to the non-bus ports) with a peripheral. Anyone who needs to be able to write their own verification tests will need the ability to drive ports and check outputs.

### Regression Testing Tool

It is expected that TBGen will offer a significant improvement in simulation speed for regression testing because the bulk of the functionality from the models used in the testbench has been stripped away, thereby reducing dramatically the complexity of the simulation. A further advantage is that no licenses are required for the regression tests to any tools except, of course, the simulator license of choice. By linking the sampling of outputs to the correct strobing lines, maximum flexibility to change the device under test is permitted, so long as the functional performance is equivalent.

Regression testing using TBGen can be used effectively to repeat simulations to verify that modifications have not compromised functionality, and also (potentially) that the same simulation will run on RTL source and different versions of netlist with, for example, typical best and worse timings.

### Market Able Product

Since this tool provides a portable method of delivering an obfuscated verification suite & a means of improving the throughput of regression testing, it will have value to anyone who designs or uses IP blocks: SoC's ASICs ASSPs, peripherals.

Since the tool only eases part of the design process, rather than being particularly key to the process of SoC design, this is a tool which ARM could market as a CAE product to the IP community.

### Required Features

General Considerations

Considerable thought needs to be given to the features that TBGen will support to ensure that it will be both useful and usable for large designs and long simulations.

The tool must be able to convert large POC files quickly and without excessive memory usage or the use of intermediate files (file i/o is unacceptably slow).

The tool must be designed such that the output file does not consume excessive disk space. The size of this file is determined by the number of i/o, the length of the simulation, and the i/o activity. TBGen must be appropriate to large designs and long simulations. Tricks need to be used to minimise the size, for example:

a/ Alias real i/o names to compressed names (eg I0, O1, etc.).

b/ Generate clocks in 1-line statements or simple models.

c/ Only sample outputs (& bidirectionals when they are outputs) at the required times, and under the control of the TBGen user, i.e. provide flexibility here. An alternative to sampling outputs is checking for the transition times (discussed later).

d/ Use Verilog/VHDL setup/hold checkers & 1 data-value check rather than multiple data value checks.

e/ Group related signals together as buses to minimise the number of lines in the TBGen output file.

A graphical front-end should be considered to ease the process of generating the TBGen control files.

Some prototyping & experimentation will be necessary before the full technical specification for TBGen can be finalised.

Driving Inputs and Sampling Outputs

Any transitions on input pins need to re-created at the same time that they occur in the original simulation. This is trivial to implement in TBGen.

Outputs fall into two categories:

a/ outputs that are intended to be strobed by other signals, for example DATA bus is sampled by RD strobe rising (the strobing signal might in general be a DUT input or a DUT output). These will be referred to as strobed outputs.

b/ outputs that are not strobed, for example the RD strobe in the case where it is a DUT output. These will be referred to as non-strobed outputs.

Strobed outputs need to be sampled at the appropriate time, as specified by the TBGen user, on the appropriate edge of a strobe line in the regression simulation. The output is then tested at the relevant simulation time, including setup & hold checks, see below. Another means of strobing outputs with TBGen is to sample them at a specific time which originates from the timing in the reference simulation (not as useful, as it ignores any “jitter” on the strobe in the regression simulation).

To ensure that outputs (strobed and non-strobed alike) do not toggle unnecessarily, and that they are tri-stated when expected (even if this is not required by a specification) TBGen will support a feature whereby all transitions on output pins can be monitored and verify that they are valid when they occur, plus/minus a specified timing tolerance. A non-strobed transition may not violate any specifications, but could cause side effects in an external device and additional power consumption.

For non-strobed output signals, e.g. the strobe signal itself or an asynchronous interface output, the requirement is that the correct transition occurs within a defined window around the original transition instant. Alternatively, it may be desired to define a sampling period and constrain the window around a regular tick.

Bidirectional Ports

To allow for pins which are used for both input and output, another signal will need to be available which determines when the pin should be driven from the test bench. This has to be added to the signals logged in the POC file, and can be derived from either the DUT or the test bench.

Care needs to be taken to avoid problems which result in variations of the DUT timing due for example to use of different libraries with detailed timing differences or simulations under different conditions. An example of what can go wrong occurs in the case where the reference simulation is performed under best-case timing, but the regression simulation is under worst-case and the bidirectional signal turns from output to input. In this example it is possible/likely that the input will be driven too soon resulting in a conflict (pad is not yet high impedance but is being driven) which would produce a simulator message.

Setup and Hold Timing Checks

In addition to strobing output signals based on other signals, TBGen will provide a setup/hold feature whereby the value is additionally tested before and after the actual strobe instant. This accommodates variations in the strobe line timing, which should also move the setup and hold sampling points. This could be implemented by detecting the time at which a signal changes and comparing this with the expected time.

Since there will typically be only a few different sets of setup and hold conditions for pins in a particular SoC or IP block, TBGen will allow the user to define timing specifications, and later associate these with particular pins.

Clocks

Clocks which are DUT inputs should be generated intelligently, rather than requiring a line of code for each transition.

Filtering out of Pins

TBGen will allow POC signals to be filtered out, i.e. not transferred into the TBGen output file. There is no requirement to trace every pin on the DUT. This can be useful for clocks, and also pins which are known to be non-compliant.

Literals

The TBGen configuration file will allow Verilog/VHDL to be produced directly into the TBGen output file. This could be, for example, a boilerplate or even RTL code. In this way the user can specify signals internal to the test bench such as clock signals or combinatorial functions of the DUT signals.

Minimisation of TBGen output file size

To keep the simulation file short, external pin names should be replaced with a simple sequence of names, e.g. I1,I2,I3,O1,O2,O3. Similarly, values should be expressed in Hex where possible. Any error messages to appear in the regression test must however reference the original name.

To optimise memory usage, it is not practical to present the TBGen output file as a single RTL source file. A combination of source file and test vector file will be needed. The method of reading in test vectors should consider the efficiency of file access speed.

TBGen should support a feature whereby signals which are busses or which share the same strobe requirement can be grouped together to keep the TBGen output file compact.

Any other ideas to minimise the file size will be considered!

HDL Language

Every construct implied by a TBGen feature must be practical to implement using both Verilog and VHDL. Any test vector files should be common to either option. A particular consideration arises from the limited file handling capabilities of Verilog: it may be necessary to write ‘C’ code to interface to the Verilog to overcome file i/o restrictions.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims

We claim:

1. A method of creating a model of a data processing apparatus having a subsystem circuit under test and one or more surrounding circuits operable to provide input signals to and receive output signals from said subsystem circuit, said method comprising the steps of:
conducting a simulation of said data processing apparatus performing a test sequence of data processing operations including simulating operation of both said subsystem under test and said one or more surrounding circuits using a subsystem circuit model and a model of said one or more surrounding circuits;
recording input signals to and output signals from said subsystem circuit whilst performing said test sequence of data processing operations; and
using at least a representation of said recorded input signals to form a reduced model to replay said recorded input signals to said subsystem circuit model without requiring a periodic sampling reference and apply a plurality of sampling rules to output signals of said subsystem circuit model to sample said output signals and to compare said output signals with one or more predetermined characteristics indicative of correct operation;
whereby said subsystem model and said reduced model may be used to simulate said subsystem performing said test sequence of data processing operations without simulating operation of said one or more surrounding circuits.

2. A method as claimed in claim 1, wherein formation of said reduced model uses one or more configuration files including data specifying input signals to said subsystem circuit, output signals from said subsystem circuit and bi-directional signals exchanged with said subsystem circuit.

3. A method as claimed in claim 2, wherein signals from said subsystem are used to determine when bi-directional signals can be driven making allowance for variations in delays inherent in output loads.

4. A method as claimed in claim 1, wherein said reduced model includes a rule having an output signal time window within which a change in said output signal to a predetermined output signal value should occur to be indicative of correct operation.

5. A method as claimed in claim 4, wherein said predetermined output signal value is one of: high; low; changed; and high impedance.

6. A method as claimed in claim 1, wherein within said data processing apparatus at least one of said output signals is a strobe output signal used to trigger sampling of at least one strobed output signal, said reduced model including a rule whereby a change in said strobe output signal is detected and used to verify the correct state of the output signal.

7. A method as claimed in claim 6, wherein said rule includes a strobe output signal time window within which a change in said strobe output signal to a predetermined strobe output signal value should occur to be indicative of correct operation.

8. A method as claimed in claim 6, wherein said rule includes a strobed output signal time window within which said strobed output signal should hold a predetermined strobed output signal value to be indicative of correct operation.

9. A method as claimed in claim 8, wherein said strobed output signal time window is non-symmetrically disposed about a time when said strobed output signal is sampled.

10. A method as claimed in claim 8, wherein said strobed output signal time window is at least partially surrounded by a settling time window within which said strobed output signal is permitted to change.

11. A method as claimed in claim 10, wherein said settling time window is at least partially surrounded by a settled time window within which said strobed output signal is not permitted to change.

12. A method as claimed in claim 1, wherein said full subsystem circuit model from which said input signals and said output signals are recorded may be different from that to which said input signals are subsequently replayed and from which output signals are subsequently analysed.

13. A method as claimed in claim 12, wherein said full subsystem circuit model may change between different versions during regression testing.

14. A method as claimed in claim 12, wherein said full subsystem circuit model may change between being one of an RTL model, a netlist model or other software view.

15. A method as claimed in claim 1, wherein changes in at least one of said output signals other than at sampling points for that output signal are also monitored.

16. A method as claimed in claim 1, comprising recording progress messages for replay during regression testing.

17. Apparatus for creating a model of a data processing apparatus having a subsystem circuit under test and one or more surrounding circuits operable to provide input signals to and receive output signals from said subsystem circuit, said apparatus comprising:
logic operable to conduct a simulation of said data processing apparatus performing a test sequence of data processing operations including simulating operation of both said subsystem under test and said one or more surrounding circuits using a subsystem circuit model and a model of said one or more surrounding circuits;
logic operable to record input signals to and output signals from said subsystem circuit whilst performing said test sequence of data processing operations; and
logic using at least a representation of said recorded input signals and one or more configuration files to form a reduced model to replay said recorded input signals to said subsystem circuit model and apply a plurality of sampling rules to output signals of said subsystem circuit model to sample said output signals and to compare said output signals with one or more predetermined characteristics indicative of correct operation;
whereby said subsystem model and said reduced model may be used to simulate said subsystem performing said test sequence of data processing operations without simulating operation of said one or more surrounding circuits.

18. A computer program product comprising a computer program for controlling a computer to perform a method as claimed in any one of claims 1 to 16.

19. A method of modelling a data processing apparatus having a subsystem circuit under test and one or more surrounding circuits operable to provide input signals to and receive output signals from said subsystem circuit, said method comprising the steps of:
providing a subsystem circuit model and a reduced model;
using said reduced model to apply a sequence of previously recorded input signals to a model of said subsystem circuit, said input signals corresponding to those provided by said one or more surrounding circuits to said subsystem circuit when performing a test sequence of data processing operations; and
using said reduced model to apply a sampling rule associated with each output signal of said subsystem circuit to sample said output signal and compare said output signal with one or more predetermined characteristics indicative of correct operation.

20. A method as claimed in claim 19, wherein said reduced model includes a rule having an output signal time window within which a change in said output signal to a predetermined output signal value should occur to be indicative of correct operation.

21. A method as claimed in claim 20, wherein said predetermined output signal value is one of:
high;
low;
changed; and
high impedance.

22. A method as claimed in claim 19, wherein within said data processing apparatus at least one of said output signals is a strobe output signal used to trigger sampling of at least one strobed output signal, said reduced model including a rule whereby a change in said strobe output signal is detected and used to trigger sampling within said reduced model of said at least one strobed output signal.

23. A method as claimed in claim 22, wherein said rule includes a strobe output signal time window within which a change in said strobe output signal to a predetermined strobe output signal value should occur to be indicative of correct operation.

24. A method as claimed in claim 22, wherein said rule includes a strobed output signal time window within which said strobed output signal should hold a predetermined strobed output signal value to be indicative of correct operation.

25. A method as claimed in claim 24, wherein said strobed output signal time window is non-symmetrically disposed about a time when said strobed output signal is sampled.

26. A method as claimed in claim 24, wherein said strobed output signal time window is at least partially surrounded by a settling time window within which said strobed output signal is permitted to change.

27. A method as claimed in claim 26, wherein said settling time window is at least partially surrounded by a settled time window within which said strobed output signal is not permitted to change.

28. A method as claimed in claim 19, wherein said full subsystem circuit model from which said input signals and said output signals are recorded may be different from that to which said input signals are subsequently replayed and from which output signals are subsequently analysed.

29. A method as claimed in claim 28, wherein said full subsystem circuit model may change between different versions during regression testing.

30. A method as claimed in claim 28, wherein said full subsystem circuit model may change between being one of an RTL model, a netlist model or other software view.

31. A method as claimed in claim 19, wherein changes in at least one of said output signals other than at sampling points for that output signal are also monitored.

32. Apparatus for modelling a data processing apparatus having a subsystem circuit under test and one or more surrounding circuits operable to provide input signals to and receive output signals from said subsystem circuit, said apparatus comprising:
logic providing a subsystem circuit model and a reduced model;
logic using said reduced model to apply a sequence of previously recorded input signals to a model of said subsystem circuit, said input signals corresponding to those provided by said one or more surrounding circuits to said subsystem circuit when performing a test sequence of data processing operations; and
logic using said reduced model to apply a sampling rule associated with each output signal of said subsystem circuit to sample said output signal and compare said output signal with one or more predetermined characteristics indicative of correct operation.

33. A computer program product comprising a computer program for controlling a computer to perform a method as claimed in any one of claims 19 to 31.

34. A reduced hardware model synthesised from said reduced model of claim 1.
